(19) United States
(12) Patent Application Publication
(10) Pub. No.: US 2018/0297528 A1
(43) Pub. Date: Oct. 18, 2018

(54) SIDE VIEW MIRROR WIPER SYSTEM

(71) Applicant: Shannon Carr, Milton, WA (US)

(72) Inventor: Shannon Carr, Milton, WA (US)

(21) Appl. No.: 15/488,521

(22) Filed: Apr. 17, 2017

(51) Int. Cl. B60R 1/06; B60S 1/08; B60S 1/38; B60S 1/16; B60S 1/34

(52) U.S. Cl. CPC B60R 1/0602; B60S 1/08; B60S 1/34; B60S 1/16; B60S 1/38

(57) ABSTRACT

Side view mirror wiper system is a wiper assembly for a vehicle door mirror which allows a user to activate a switch within the drivers compartment to send electrical current to a DC motor within the mirror housing to turn on a wiper and clear rain, dew, snow, and dust from the mirror surface to allow clear side and rear viewing through the mirrors to promote safer driving conditions.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of vehicle window wipers and more specifically relates to a wiper system for a vehicle door rearview mirror.

### 2. Description of the Related Art

Almost all motor vehicles such as cars, trucks, trains, airplanes, etc. come equipped with windshield wipers. The wiper typically consists of a long arm with rubber blade that touches the windscreen. The arm at one end is pivotally connected to a driving mechanism which swings the blade back and forth over the glass, wiping rain, water, moisture, dirt etc. Most vehicles are equipped with two windshield wipers that cover much of the surface of the windshield allowing clear vision in rain or wet climates.

It is common to see the use of a wiper system on rear windows of vehicles, to allow a clear rear view. In absence of a wiper system, the driver usually has to stop the vehicle and manually clear the window surface of raindrops, dust, sand, etc. However this is laborious and time consuming, and less practical in rainy or wet climates where the user will have to frequently clean the glass. To a less extent, such a utility has also been incorporated into headlight glass, particularly in places with inclement weather conditions. Small wipers are installed on the headlight assembly which keeps the glass clean of dirt, snow etc., thus providing proper lightening.

Vehicles are equipped with side mounted rear view mirrors, commonly known as wing mirror, fender mirror, door mirror, or side mirror, for side and rear view. These are particularly useful while turning the vehicle or backing up, or when parking the vehicle. Like window glass, side view mirrors also get soiled or covered with raindrops, dew etc. Cleaning the mirrors are time consuming, and when cleaned with a cloth, often leaves streaks. Moreover, the driver may forgot to clean the mirrors, and it is less practical to stop the vehicle while on the road to clean the mirror. Thus the driver may only depend upon the interior rear view mirror. Operating the vehicle with soiled mirrors is unsafe and may result in an accident. Particularly large vehicles such as trucks with trailers are more prone to accidents if they cannot see a vehicle coming from side. Thus providing a wiper system for vehicle side rear-view mirrors could provide relief to drivers, and improve safety of the vehicle.

Ideally, a rearview mirror wiper should provide a means to wipe rain, snow, dew, and debris from a mirror, and yet would operate reliably and be manufactured at a modest expense. Thus, a need exists for a reliable vehicle door mirror wiper system to avoid the above-mentioned problems.

### BRIEF SUMMARY OF THE INVENTION

In view of the foregoing disadvantages inherent in the known rearview mirror wiper assembly art, the present invention provides a novel side view mirror wiper system. The general purpose of the present invention, which will be described subsequently in greater detail is to provide a wiper system for a vehicle door rearview mirror.

A side view mirror wiper system is disclosed herein comprising a mirror housing having an outside surface, and an interior volume including a motor assembly having a drive shaft, a transmission assembly mechanically connected to the motor assembly, a wiper arm mechanically connected to the transmission assembly, a wiper blade mechanically connected to the wiper arm, and a mirror including an interior surface, an exterior surface, and an aperture therethrough. The mirror is pivotally connected within the interior volume of the mirror housing such that the mirror can be adjusted with respect to the position of a driver within the driver's compartment of a vehicle for clear rear and side viewing for safety. The mirror's aperture is adapted to allow a wiper arm to pass through from the interior volume to the exterior surface.

A power source is adapted to supply electrical current to the side view mirror wiper system via a wiring harness passing through the mirror housing connecting the motor assembly to the power source. A power switch is located within a driver's compartment for ease of access, and electrically connected to the wiring harness to supply electrical current to the motor assembly. The motor assembly includes a DC (direct current) motor and is adapted to be utilized in conjunction with a power source, which drives the wiper arm through a range of motion necessary to wipe the exterior surface of the mirror. The motor assembly and transmission assembly are of a size adapted to be contained within the interior volume of the mirror housing. The power source provides electrical current to the motor assembly which drives the drive shaft in a circular motion.

The transmission assembly converts the circular motion of the drive shaft to an oscillating motion, which is transferred to the wiper arm that is mechanically connected to the transmission assembly, and allows the wiper arm with a wiper blade to sweep over the exterior surface of the mirror. The wiper blade is formed from a rubber material and adapted to clean the exterior surface of the mirror by applying even pressure on the exterior surface of the mirror throughout its range of motion, which covers substantially the entire exterior surface of the mirror. The wiper arm is further adapted to pivot outwardly from the exterior surface of the mirror to allow replacement of the wiper blade as needed.

The present invention holds significant improvements and serves as a side view mirror wiper system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, side view mirror wiper system constructed and operative according to the teachings of the present invention.

FIG. 1 shows a perspective view illustrating a side view mirror wiper system in an in-use condition according to an embodiment of the present invention.

FIG. 2 is a front view illustrating a side view mirror wiper system according to an embodiment of the present invention of FIG. 1.

FIG. 3A and FIG. 3B show the interior volume with motor assembly and back view of the mirror housing respectively, according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a rearview mirror wiper and more particularly to a side view mirror wiper system as used to improve the ability of a user to wipe rain, snow, dew, and dust from a vehicle door rearview mirror to provide clear viewing toward the rear of a vehicle and improve safety while driving.

Generally speaking, side view mirror wiper system is a wiper assembly for a vehicle door mirror which allows a user to activate a switch within the drivers compartment to send electrical current to a DC motor within the mirror housing to turn on a wiper and clear rain, dew, snow, and dust from the mirror surface to allow clear side and rear viewing through the mirror to promote safer driving conditions.

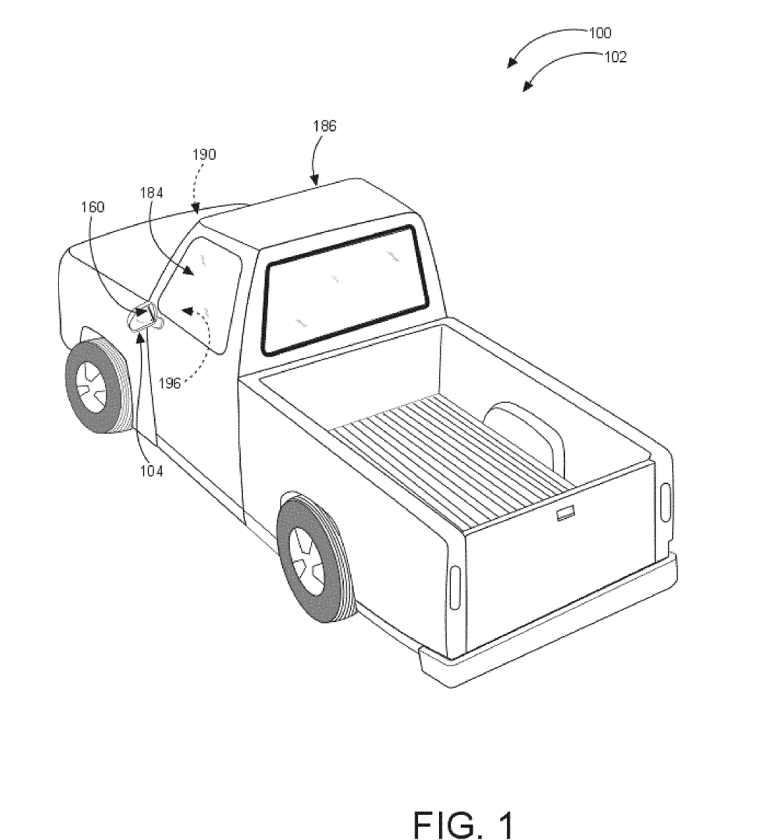

Referring to the drawings by numerals of reference there is shown in FIG. 1, a perspective view illustrating a side view mirror wiper system 100 in an in-use condition 102 according to an embodiment of the present invention.

Side view mirror wiper system 100 is disclosed herein comprising mirror housing 104 having outside surface 108, and interior volume 114 including motor assembly 130 having drive shaft 136, transmission assembly 150 mechanically connected to motor assembly 130, wiper arm 160 mechanically connected to transmission assembly 150, wiper blade 164 mechanically connected to wiper arm 160, and mirror 170 including interior surface 172, exterior surface 176, and aperture 180 therethrough. Mirror 170 is pivotally connected within interior volume 114 of mirror housing 104 such that mirror 170 can be adjusted with respect to the position of a driver within driver's compartment 184 of vehicle 186 for clear rear and side viewing for safety. Mirror's aperture 170 is adapted to allow wiper arm 160 to pass through from interior volume 114 to exterior surface 176.

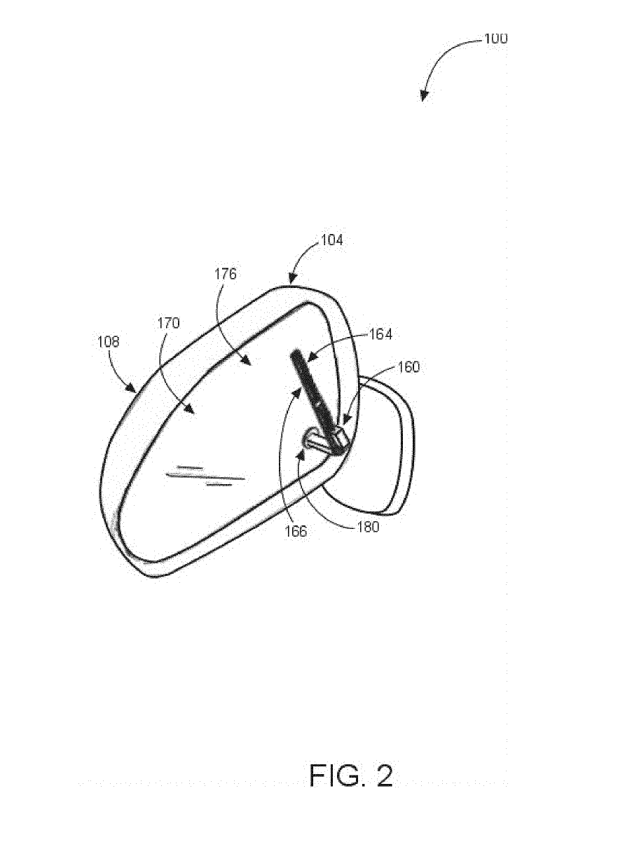

Referring now to FIG. 2, a front view illustrating a side view mirror wiper system 100 according to an embodiment of the present invention.

Power source 190 is adapted to supply electrical current to side view mirror wiper system 100 via wiring harness 194 passing through mirror housing 104 connecting motor assembly 130 to power source 190. Power switch 196 is located within driver's compartment 184 for ease of access, and electrically connected to wiring harness 194 to supply electrical current to motor assembly 130. Motor assembly 130 includes a DC (direct current) motor 132 and is adapted to be utilized in conjunction with power source 190, which drives wiper arm 160 through a range of motion necessary to wipe exterior surface 176 of mirror 170. Motor assembly 130 and transmission assembly 150 are of a size adapted to be contained within interior volume 114 of mirror housing 104. Power source 190 provides electrical current to motor assembly 130 which drives drive shaft 136 in a circular motion.

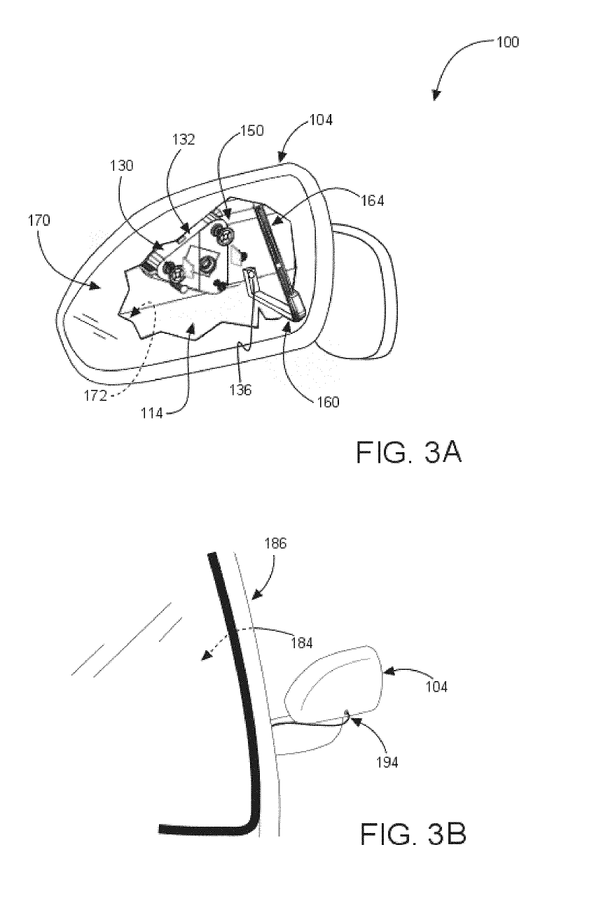

Referring now to FIG. 3A and FIG. 3B showing the interior volume 114 with motor assembly 130, and back view of the mirror housing 104 respectively, according to an embodiment of the present invention.

Transmission assembly 150 converts the circular motion of drive shaft 136 to an oscillating motion, which is transferred to wiper arm 160 that is mechanically connected to transmission assembly 150, and allows wiper arm 160 with wiper blade 164 to sweep over exterior surface 176 of mirror 170. Wiper blade 164 is formed from rubber material 166 and adapted to clean exterior surface 176 of mirror 170 by applying even pressure on exterior surface 176 of mirror 170 throughout its range of motion, which covers substantially the entire exterior surface 176 of mirror 170. Wiper arm 160 is further adapted to pivot outwardly from exterior surface 176 of mirror 170 to allow replacement of wiper blade 164 as needed.

Side view mirror wiper system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A side view mirror wiper system comprising:
a mirror housing having;
an outside surface; and
an interior volume including;
a motor assembly including a drive shaft;
a transmission assembly mechanically connected to said motor assembly;
a wiper arm mechanically connected to said transmission assembly; and
a wiper blade mechanically connected to said wiper arm;
a mirror including an interior surface, an exterior surface, and an aperture therethrough;
wherein said mirror is pivotally connected within said interior volume of said mirror housing such that said mirror is adapted to be adjusted with respect to a position of a driver within a driver's compartment of a vehicle for clear rear viewing for safety;
wherein said aperture is adapted to allow said wiper arm to pass therethrough from said interior volume to said exterior surface;
a power source adapted to supply electrical current to said side view mirror wiper system;
a wiring harness adapted to connect said motor assembly to said power source;
a power switch electrically connected to said wiring harness adapted to supply electrical current to said motor assembly.

2. The side view mirror wiper system of claim 1 wherein said motor assembly includes a DC (direct current) motor and is adapted to be utilized in conjunction with said power source.

3. The side view mirror wiper system of claim 2 wherein said motor assembly is adapted to drive said wiper arm through a range of motion necessary to wipe said exterior surface of said mirror.

4. The side view mirror wiper system of claim 3 wherein said motor assembly and said transmission assembly are of a size adapted to be contained within said interior volume of said mirror housing.

5. The side view mirror wiper system of claim 2 wherein said power source provides electrical current to said motor assembly which drives said drive shaft in a circular motion.

6. The side view mirror wiper system of claim 3 wherein said transmission assembly is adapted to convert said circular motion of said drive shaft to an oscillating motion.

7. The side view mirror wiper system of claim 6 wherein said oscillating motion is transferred to said wiper arm which is mechanically connected to said transmission assembly.

8. The side view mirror wiper system of claim 7 wherein said oscillating motion of said wiper arm is adapted to allow said wiper arm with said wiper blade to sweep over said exterior surface of said mirror.

9. The side view mirror wiper system of claim 8 wherein said wiper blade is formed from a rubber material adapted to clean said exterior surface of said mirror.

10. The side view mirror wiper system of claim 8 wherein said wiper arm is adapted to apply even pressure on said exterior surface of said mirror throughout said wiper arm range of motion.

11. The side view mirror wiper system of claim 10 wherein said wiper arm range of motion covers substantially an entire said exterior surface of said mirror.

12. The side view mirror wiper system of claim 9 wherein said wiper arm is adapted to pivot outwardly from said exterior surface of said mirror to allow replacement of said wiper blade as needed.

13. The side view mirror wiper system of claim 1 wherein said wiring aperture is adapted to allow said wiring harness to pass therethrough and connect to said power source.

14. The side view mirror wiper system of claim 1 wherein said power switch is adapted to be located within a driver's compartment for ease of access.
